(19) United States
(12) Patent Application Publication
(10) Pub. No.: US 2019/0110407 A1
(43) Pub. Date: Apr. 18, 2019

(54) INFLATABLE PLANTING DEVICE

(71) Applicants: Chunghwa Picture Tubes, LTD., Taoyuan City (TW); National Pingtung University of Science and Technology, Pingtung (TW)

(72) Inventors: Shih-Wei Su, Taoyuan City (TW); Ru-Yi Hsieh, Taoyuan City (TW); Tsung-Meng Wu, Pingtung County (TW)

(73) Assignees: Chunghwa Picture Tubes, LTD., Taoyuan City (TW); National Pingtung University of Science and Technology, Pingtung (TW)

(21) Appl. No.: 15/821,852

(22) Filed: Nov. 24, 2017

(30) Foreign Application Priority Data
Oct. 12, 2017 (CN) 201710945072.7

(51) Int. Cl. A01G 9/02; A01G 27/00

(52) U.S. Cl. CPC A01G 9/023; A01G 27/00

(57) ABSTRACT

An inflatable planting device including a storage tank, a cultivation tank, a field planting tray and a plurality of planting frames is provided. The storage tank has a first air bag. The cultivation tank has a second air bag, and is located on the storage tank. The field planting tray has a mesh air bag defining a plurality of plant holes, and the field planting tray is located on the cultivation tank. The planting frames have a third air bag, and are connected to a periphery of the storage tank, the cultivation tank and the field planting tray through a plurality of connecting holes, where the connecting holes connect the first air bag, the second air bag, the mesh air bag and the third air bag to make the storage tank, the cultivation tank, the field planting tray and the planting frames to form an integrated connection.

### CROSS-REFERENCE TO RELATED APPLICATION

This application claims the priority benefit of China application serial no. 201710945072.7, filed on Oct. 12, 2017. The entirety of the above-mentioned patent application is hereby incorporated by reference herein and made a part of this specification.

### BACKGROUND OF THE INVENTION

### Field of the Invention

The invention relates to a planting device, and particularly relates to an inflatable planting device.

### Description of Related Art

As speeds for urbanization and land desertification become faster and faster, general crops or plants that are planted in the soil are not only influenced by a soil structure, a soil composition, a soil fertility or a rainwater level, an area of the cultivated land thereof also becomes more and more less, which causes an unstable supply of the crops or plants, and it is increasingly unable to meet the needs of today's population or market. Therefore, at present, a multi-layer planting device is often used to solve the problem of insufficient planting area.

However, a volume of the multi-layer planting device is huge, and generally has a hard structural composition (a material thereof is, for example, hard glass or acrylic that cannot be compressed, bended, folded, etc.), which results in a fact that it is difficult to be transported and assembled. Therefore, how to improve the convenience of transportation and assembling of the planting device is one of the most urgent issues for related technicians.

### SUMMARY OF THE INVENTION

The invention is directed to an inflatable planting device, which has good convenience in transportation and assembling.

An embodiment of the invention provides an inflatable planting device including a storage tank, a cultivation tank, a field planting tray and a plurality of planting frames. The storage tank has a first air bag. The cultivation tank has a second air bag, and is located on the storage tank. The field planting tray has a mesh air bag defining a plurality of plant holes, and the field planting tray is located on the cultivation tank. The planting frames have a third air bag, and are connected to a periphery of the storage tank, the cultivation tank and the field planting tray through a plurality of connecting holes, where the connecting holes connect the first air bag, the second air bag, the mesh air bag and the third air bag to make the storage tank, the cultivation tank, the field planting tray and the planting frames to form an integrated connection.

In an embodiment of the invention, a ratio between a cross-sectional area of the connecting holes in a radial direction and a contact area of the planting frames and the storage tank is greater than 0 and smaller than or equal to 1/10.

In an embodiment of the invention, a ratio between a cross-sectional area of the connecting holes in a radial direction and a contact area of the planting frames and the cultivation tank is greater than 0 and smaller than or equal to 1/10.

In an embodiment of the invention, when the first air bag, the second air bag, the mesh air bag and the third air bag are in an inflated state, the storage tank has a thickness d1, the cultivation tank has a thickness d2, the field planting tray has a thickness d3, and the planting frames have a thickness d4.

In an embodiment of the invention, when the first air bag, the second air bag, the mesh air bag and the third air bag are in a non-inflated state, the thicknesses of the storage tank, the cultivation tank, the field planting tray and the planting frames are respectively defined as d11, d12, d13 and d14, and d1>d11, d2>d12, d3>d13, d4>d14.

In an embodiment of the invention, when the first air bag, the second air bag, the mesh air bag and the third air bag are in a non-inflated state, the storage tank directly contacts the cultivation tank, and the cultivation tank directly contacts the field planting tray.

In an embodiment of the invention, when the first air bag, the second air bag, the mesh air bag and the third air bag are in a non-inflated state, the storage tank, the cultivation tank, the field planting tray or the planting frames are bended to present a folding state.

In an embodiment of the invention, the inflatable planting device further includes a first water pipe located in the planting frames, and two ends of the first water pipe are respectively located in the storage tank and the cultivation tank.

In an embodiment of the invention, the inflatable planting device further includes a pump located in the storage tank and connected to the first water pipe.

In an embodiment of the invention, the inflatable planting device further includes a second water pipe located in the planting frames, and two ends of the second water pipe are respectively located in the storage tank and the cultivation tank.

According to the above description, in the inflatable planting device provided by the invention, since the storage tank, the cultivation tank, the field planting tray and the planting frames respectively have the first air bag, the second air bag, the mesh air bag and the third air bag, and the first air bag, the second air bag, the mesh air bag and the third air bag are connected through the connecting holes, the storage tank, the cultivation tank, the field planting tray and the planting frames have an integrated connection, and the inflatable planting device has good convenience in transportation and assembling.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional view of an inflatable planting device under an inflated state according to an embodiment of the invention.

FIG. 2 is a side view of the inflatable planting device under the inflated state according to an embodiment of the invention.

FIG. 3 is a cross-sectional view of the inflatable planting device under the inflated state according to an embodiment of the invention.

FIG. 4 is a side view of an inflatable planting device under the non-inflated state according to an embodiment of the invention.

FIG. 5 is a side view of a field planting tray under the non-inflated state according to another embodiment of the invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Referring to the drawings of the invention for a further understanding of the invention. However, the invention can be embodied in various forms, and is not limited to the embodiments provided below. Moreover, the thickness of the layers and regions in the drawings is enlarged for clarity's sake. The same reference numbers are used in the drawings and the description to refer to the same or like parts, and description of the same parts are not repeated in the following paragraphs.

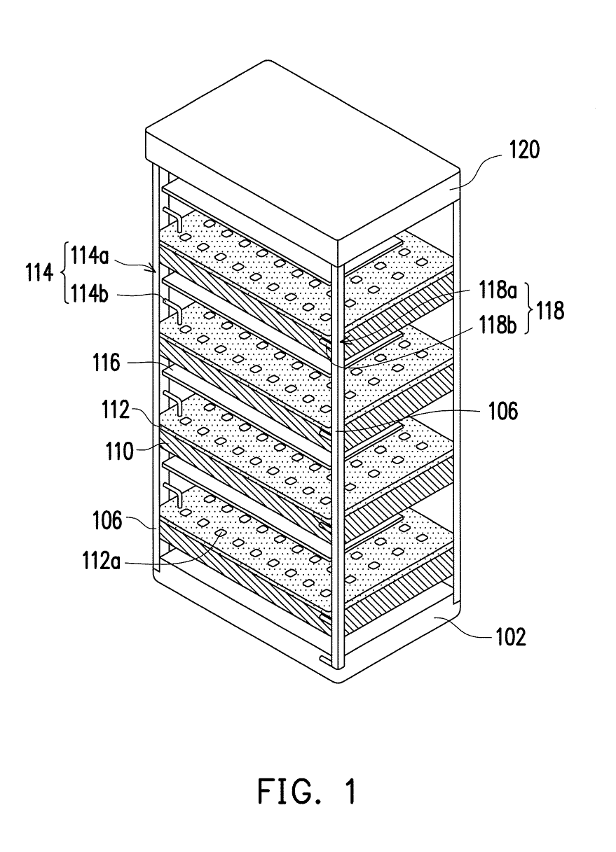

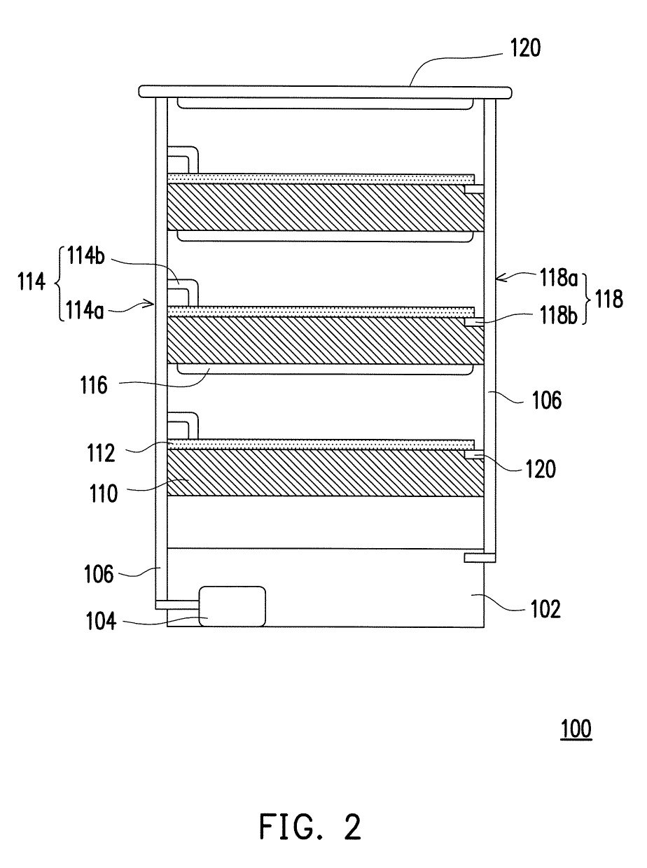

FIG. 1 is a three-dimensional view of an inflatable planting device under an inflated state according to an embodiment of the invention. FIG. 2 is a side view of the inflatable planting device under the inflated state according to an embodiment of the invention.

Referring to FIG. 1 and FIG. 2, the inflatable planting device 100 includes a storage tank 102, a cultivation tank 110, a field planting tray 112 and a plurality of planting frames 106. The storage tank 102 may be used for storing a culture medium that provides nutrients for plants or crops. The cultivation tank 110 is located on the storage tank 102, and is used for containing the aforementioned culture medium. The field planting tray 112 is located on the cultivation tank 110, and includes a plurality of plant holes 112a used for placing the plants or crops. For example, the plants may be placed in the plant holes 112a, and roots thereof are immersed in the culture medium in the cultivation tank 110. The planting frames 106 are connected to a periphery of the storage tank 102, the cultivation tank 110 and the field planting tray 112 through a plurality of connecting holes 108, so as to support one or more of the cultivation tanks 110 and the field planting trays 112 located on the storage tank 102.

Besides, in some embodiments, the planting frame 106 includes a first water pipe 114, which may be located in the planting frame 106, and may include a first part 114a located in the planting frame 106 (i.e. the part located at the side of the cultivation tank 110) and a second part 114b extending to a center of the cultivation tank 110 (i.e. the part located on top of the cultivation tank 110). In some other embodiments, the first water pipe 114 may also be disposed on an outer surface of the planting frame 106. Two ends (for example, a water inlet and a water outlet) of the first water pipe 114 may be respectively located in the storage tank 102 and the cultivation tank 110, and the culture medium stored in the storage tank 102 may be injected to the cultivation tank 110 through a pump 104 located in the storage tank 102. In some embodiments, the first water pipe 114 is a part of the planting frame 106, for example, when the planting frame 106 is a hollow structure, the first water pipe 114 is the hollow part of the planting frame 106. In some other embodiments, the first water pipe 114 is not a part of the planting frame 106, for example, the first water pipe 114 may be disposed in the planting frame 106 or disposed on the outer surface of the planting frame 106, and a material of the first water pipe 114 may be a commonly used water pipe material such as plastic, etc. On the other hand, the planting frame 106 further includes a second water pipe 118, which may be located in the planting frame 106, and may include a first part 118a located in the planting frame 106 (i.e. the part located at the side of the cultivation tank 110) and a second part 118b extending to the center of the cultivation tank 110 (i.e. the part located on top of the cultivation tank 110). Two ends (for example, a water inlet and a water outlet) of the second water pipe 118 may be respectively located in the storage tank 102 and the cultivation tank 110, and when a liquid level of the culture medium in the cultivation tank 110 is higher than a specific level, the culture medium may be flow back to the storage tank 102 in an overflow manner from the second part 118b of the second water pipe 118 through the first part 118a of the second water pipe 118. In this way, the culture medium may circulate between the cultivation tank 110 and the storage tank 102 through the first water pipe 114, the pump 104 and the second water pipe 118. In some embodiments, the first water pipe 114 and the second water pipe 118 are located in different planting frames 106.

Moreover, in some embodiments, a light board 116 may be disposed on the field planting tray 112 to provide light required by the plants or crops. The light board 116 may include one or more of light tubes, and the light tubes are, for example, fluorescent tubes, ultraviolet lamps, LED lamps or a combination thereof. In some embodiments, the light board 116 may be fixed on the bottom of another cultivation tank 110 on the field planting tray 112, such that the light may irradiate on the field planting tray 112. In some other embodiments, regarding the uppermost field planting tray 112, a top plate 120 may be disposed above the uppermost field planting tray 112 through the planting frame 106, where the plating frame 106 is, for example, connected to four corners of the top plate 120, such that the top plate 120 is well fixed above the uppermost field planting tray 112, and the light board 116 may be fixed on the bottom of the top plate 120, and the light may irradiate on the uppermost field planting tray 112.

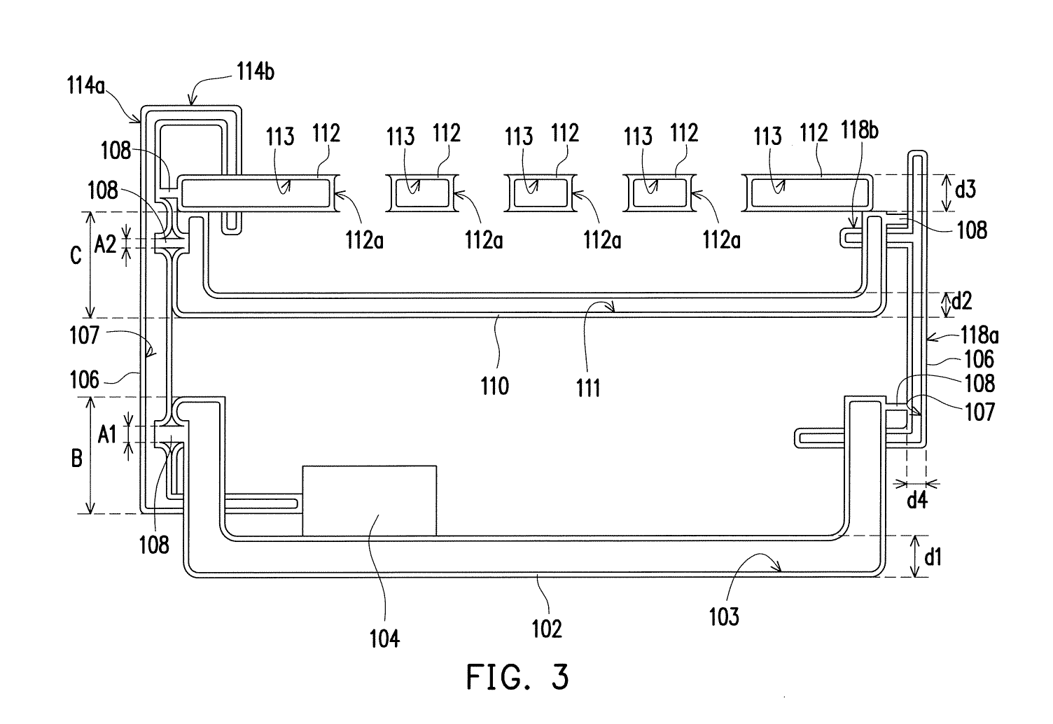

FIG. 3 is a cross-sectional view of the inflatable planting device under the inflated state according to an embodiment of the invention. For simplicity's sake, only one cultivation tank 110 and one field planting tray 112 are shown on the storage tank 102 in FIG. 3, though the invention is not limited thereto, and a plurality of cultivation tanks 110 and a plurality of field planting trays 112 may be sequentially disposed on the storage tank 102 as that shown in FIG. 1.

Referring to FIG. 3, the storage tank 102 has a first air bag 103, the cultivation tank 110 has a second air bag 111, the field planting tray 112 has a mesh air bag 113 defining a plurality of the plant holes 112a, and the planting frames 106 have a third air bag 107, and are connected to the periphery of the storage tank 102, the cultivation tank 110 and the field planting tray 112 through a plurality of the connecting holes 108 for supporting one or more of the cultivation tanks 110 and the field planting trays 112 located on the storage tank 102, where the connecting holes 108 connect the first air bag 103, the second air bag 111, the mesh air bag 113 and the third air bag 107 to make the storage tank 102, the cultivation tank 110, the field planting tray 112 and the planting frames 106 to form an integrated connection. In this way, the inflatable planting device 110 has good convenience in transportation and assembling.

For example, when the first air bag 103, the second air bag 111, the mesh air bag 113 and the third air bag 107 are in the inflated state, the storage tank 102 has a thickness d1, the cultivation tank 110 has a thickness d2, the field planting tray 112 has a thickness d3, and the planting frames 106 have thickness d4 (if the planting frame 106 is pipe like, the thickness d4 is then a magnitude of a pipe diameter), and when the first air bag 103, the second air bag 111, the mesh air bag 113 and the third air bag 107 are in the non-inflated state, the thicknesses of the storage tank 102, the cultivation tank 110, the field planting tray 112 and the planting frames 106 are respectively defined as d11, d12, d13 and d14, and d1>d11 , d2>d12, d3>d13, d4>d14. Namely, a volume of the inflatable planting device 100 under the non-inflated state is smaller than a volume of the inflatable planting device 100 under the inflated state, such that the inflatable planting device 100 under the non-inflated state is easy to be transported. On the other hand, in some embodiments, since volumes of the first air bag 103, the second air bag 111, the mesh air bag 113 and the third air bag 107 are respectively close to volumes of the storage tank 102, the cultivation tank 110, the field planting tray 112 and the planting frames 106, under the situation that gas occupies most of the volumes of the storage tank 102, the cultivation tank 110, the field planting tray 112 and the planting frames 106, a weight of the inflatable planting device 100 is much lighter than a planting device composed of materials such as hard polystyrene foam, acrylic, glass, etc. Therefore, under the situation that the volume and the weight are all reduced, the inflatable planting device 100 is not only easy to be transported, since it occupies less space before assembling (i.e. in the non-inflated state), a storage space is saved to decrease a warehousing cost. In some embodiments, a material of the storage tank 102, the cultivation tank 110, the field planting tray 112 and the planting frames 106 may be plastic or a flexible material, which is not limited by the invention.

Moreover, in some embodiments, in order to enhance a structural strength of the inflatable planting device 100, a ratio (A1/B) between a cross-sectional area Al of the connecting holes 108 in a radial direction and a contact area B of the planting frames 106 and the storage tank 102 is smaller than or equal to 1/10. In some other embodiments, a ratio (A2/C) between a cross-sectional area A2 of the connecting holes 108 in the radial direction and a contact area C of the planting frames 106 and the cultivation tank 110 is also smaller than or equal to 1/10, so as to further enhance the structural strength of the inflatable planting device 100 to increase the weight it can carry. It should be noted that a lower limit of the above ratio (A1/B or A2/C) is not particularly specified, and the spirit of the invention is met as long as the gas may pass through the connecting holes 108 (i.e. the ratio is not 0).

Moreover, the inflatable planting device 100 may further include an inflating hole (not shown) used for filling gas into the first air bag 103, the second air bag 111, the mesh air bag 113 and the third air bag 107. The number of the inflating hole may be one or plural, and the inflating holes may be distributed at any position on the storage tank 102, the cultivation tank 110, the field planting tray 112, the connecting holes 108 or the planting frames 106, as long as the inflatable plating device 100 may be changed from the non-inflated state to the inflated state, which is not limited by the invention. Moreover, the gas may be exhausted from the first air bag 103, the second air bag 111, the mesh air bag 113 and the third air bag 107 through the inflating holes, such that the inflatable plating device 100 is changed from the inflated state to the non-inflated state.

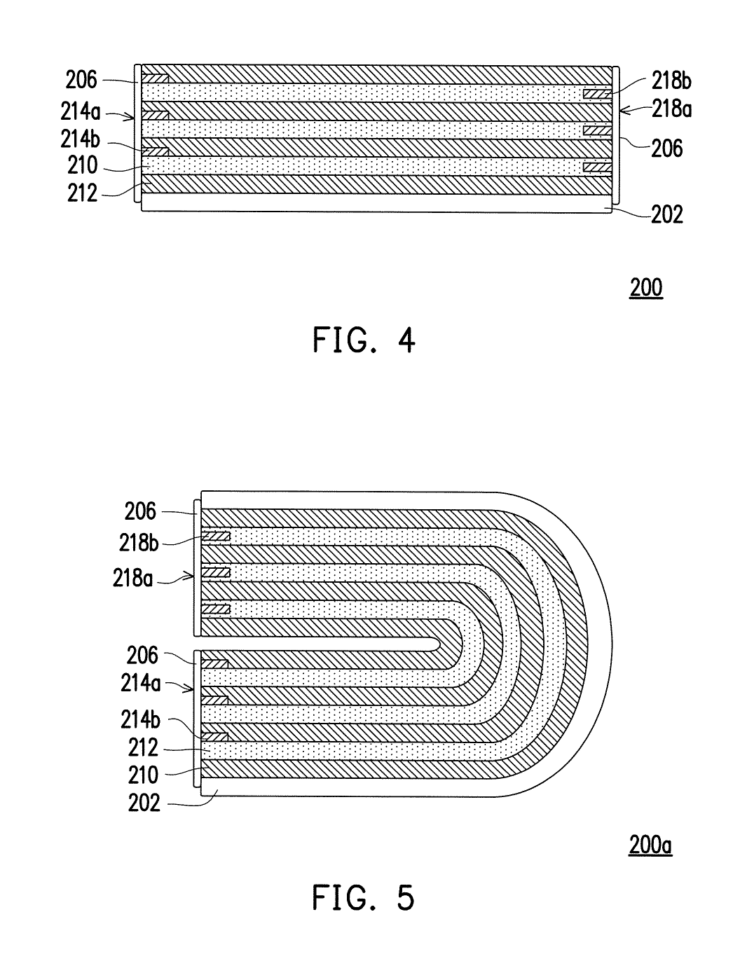

FIG. 4 and FIG. 5 are provided below to introduce a packing manner of an inflatable planting device under the non-inflated state. FIG. 4 is a side view of an inflatable planting device under the non-inflated state according to an embodiment of the invention. FIG. 5 is a side view of the field planting tray under the non-inflated state according to another embodiment of the invention.

Referring to FIG. 4, the inflatable planting device 200 is substantially similar to the inflatable planting device 100, and a difference there between is that the inflatable planting device 200 is in the non-inflated state (i.e. the first air bag, the second air bag, the mesh air bag and the third air bag are not inflated), and the storage tank 202, the cultivation tank 210, the field planting tray 212 and the planting frames 206 are stacked together in an up-and-down packing manner, such that the lowermost cultivation tank 210 directly contacts the neighbouring storage tank 202 and the field planting tray 212, and the other cultivation tanks 210 directly contact the neighbouring field planting trays 212.

Referring to FIG. 5, the inflatable planting device 200a is substantially similar to the inflatable planting device 100, and a difference there between is that the inflatable planting device 200a is in the non-inflated state (i.e. the first air bag, the second air bag, the mesh air bag and the third air bag are not inflated), and the storage tank 202, the cultivation tank 210, the field planting tray 212 and the planting frames 206 are stacked together in an bending packing manner to present a folding state.

In summary, in the inflatable planting device provided by the invention, since the storage tank, the cultivation tank, the field planting tray and the planting frames respectively have the first air bag, the second air bag, the mesh air bag and the third air bag, and the first air bag, the second air bag, the mesh air bag and the third air bag are connected through the connecting holes, the storage tank, the cultivation tank, the field planting tray and the planting frames have an integrated connection, and the inflatable planting device has good convenience in transportation and assembling.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An inflatable planting device, comprising:
a storage tank, having a first air bag;
a cultivation tank, having a second air bag, and located on the storage tank;
a field planting tray, having a mesh air bag defining a plurality of plant holes, and the field planting tray being located on the cultivation tank; and
a plurality of planting frames, having a third air bag, and connected to a periphery of the storage tank, the cultivation tank and the field planting tray through a plurality of connecting holes, wherein the connecting holes connect the first air bag, the second air bag, the mesh air bag and the third air bag to make the storage tank, the cultivation tank, the field planting tray and the planting frames to form an integrated connection.

2. The inflatable planting device as claimed in claim 1, wherein a ratio between a cross-sectional area of the connecting holes in a radial direction and a contact area of the planting frames and the storage tank is greater than 0 and smaller than or equal to 1/10.

3. The inflatable planting device as claimed in claim 1, wherein a ratio between a cross-sectional area of the connecting holes in a radial direction and a contact area of the planting frames and the cultivation tank is greater than 0 and smaller than or equal to 1/10.

4. The inflatable planting device as claimed in claim 1, wherein when the first air bag, the second air bag, the mesh air bag and the third air bag are in an inflated state, the storage tank has a thickness d1, the cultivation tank has a thickness d2, the field planting tray has a thickness d3, and the planting frames have a thickness d4.

5. The inflatable planting device as claimed in claim 4, wherein when the first air bag, the second air bag, the mesh air bag and the third air bag are in a non-inflated state, the thicknesses of the storage tank, the cultivation tank, the field planting tray and the planting frames are respectively defined as d11, d12, d13 and d14, and d1>d11, d2>d12, d3>d13, d4>d14.

6. The inflatable planting device as claimed in claim 1, wherein when the first air bag, the second air bag, the mesh air bag and the third air bag are in a non-inflated state, the storage tank directly contacts the cultivation tank, and the cultivation tank directly contacts the field planting tray.

7. The inflatable planting device as claimed in claim 1, wherein when the first air bag, the second air bag, the mesh air bag and the third air bag are in a non-inflated state, the storage tank, the cultivation tank, the field planting tray or the planting frames are bended to present a folding state.

8. The inflatable planting device as claimed in claim 1, further comprising:
a first water pipe, located in the planting frames, and two ends of the first water pipe are respectively located in the storage tank and the cultivation tank.

9. The inflatable planting device as claimed in claim 8, further comprising:
a pump, located in the storage tank, and connected to the first water pipe.

10. The inflatable planting device as claimed in claim 8, further comprising:
a second water pipe, located in the planting frames, and two ends of the second water pipe are respectively located in the storage tank and the cultivation tank.
